(19) United States
(12) Patent Application Publication
(10) Pub. No.: US 2014/0105708 A1
(43) Pub. Date: Apr. 17, 2014

(54) Method and Device for Manufacturing Book Cases

(71) Applicant: Kolbus GmbH & Co. KG, Rahden (DE)

(72) Inventor: Frank Tautz, Rahden (DE)

(73) Assignee: Kolbus GmbH & Co. KG, Rahden (DE)

(21) Appl. No.: 14/107,683

(22) Filed: Dec. 16, 2013

Related U.S. Application Data
(62) Division of application No. 13/068,714, filed on May 18, 2011.

(30) Foreign Application Priority Data
Jun. 18, 2010 (DE) 10 2010 024 232.2

(51) Int. Cl. B42C 7/00

(52) U.S. Cl. CPC B42C 7/008
USPC 412/3

(57) ABSTRACT

In a case maker (1), cover boards (2) and a spine strip (3) are joined with the glued blanks to be covered (4) in a roll-down device (12, 15). The protruding edges of the blank (4) are subsequently turned in successively arranged work stations (40, 43). Book cases (8) with different dimensions are manufactured in the form of a continuous production by adjusting at least the guides (29, 30) of the board feed (20) that align the cover boards (2) and spine strips (3), as well as the turn-in devices (44.1, 44.2) of the side turn-in station (43), to the working positions defined for the respective book case (8) to be manufactured next in synchronism with the throughfeed of the respective book cases (7, 8) and their assigned cover boards (2), spine strips (3) and blanks to be covered (4).

### RELATED APPLICATION

This is a divisional application of U.S. application Ser. No. 13/068,714 filed May 18, 2011, with the benefits thereof accorded under 35 U.S.C. §121.

### BACKGROUND

The present invention pertains to a method and a device for manufacturing book cases.

In a case maker that operates in accordance with the horizontal processing principle [Liebau, Heinze: Industrielle Buchbinderei; Beruf and Schule Publishing, 1997; p. 399 ff.], cover boards and a spine strip of pasteboard or cardboard are joined with the blanks to be covered that are provided with glue in a roll-down device, namely in an accurately registered fashion. A case maker of this type is also illustrated and described in DE 100 57 599 A1. The cover boards are removed from a board magazine and fed to the roll-down device after they are laterally aligned on guide rails together with the spine strip. The blank to be covered is moved into the roll-down plane by means of a blank cylinder synchronous to the board feed. The protruding edges of the book case are subsequently turned in in successively arranged work stations, namely either in a throughfeed mode or a while the respective book case is at a standstill, wherein the edges protruding on the head and the foot are usually turned in first and the edges on the sides are then turned in after turning in the corners. The book cases are ultimately guided between pressing rollers of a rub-down device in order to rub the board pieces down onto the blank to be covered. In a delivery section, the finished book cases are transported to a manual removal station in the form of stacks by means of a roller conveyor.

Such case makers serve for the mass production of identical book cases with high manufacturing efficiency. It is possible to manufacture different book cases in an uninterrupted fashion if they have the same format, i.e., if they have the same dimensions with respect to their open width, height, case width and spine insert width, and the blanks to be covered have the same format, but different printed content. Consequently, the known case makers are always set up for a certain book case format.

During a format change, the case maker is reset to the new dimensions while it is at a standstill. Although the essential resetting processes in these case makers have meanwhile been automated by means of a central control device and motor-driven adjusting axes systems and these resetting processes essentially take place in parallel, each format change is still associated with a time-consuming set-up process that is economically disproportionate to the actual production time, particularly with respect to smaller print runs, in which only a few book cases of the same format are manufactured.

The invention is based on the objective of developing a method and a device for manufacturing book cases of the initially cited type which respectively allow the economical manufacture of book cases in small print runs or even a print run of one.

With respect to the initially cited method and the initially cited device, this objective is attained with the characteristics disclosed in the respective characterizing portions of claims 1 and 7. Preferred additional developments are disclosed in the dependent claims.

Since the case maker is reset while production continues, i.e., while the machine is running and book cases are still processed, the time-consuming set-up processes during the standstill of the machine are eliminated such that book cases can be economically manufactured in small print runs, particularly a print run of one. The respective processing devices and processing stations are synchronized with the throughfeed of the respective book cases or book case pieces such as cover boards, spine strips and blanks to be covered, wherein the respective adjustments are carried out as soon as the corresponding processing steps of the preceding book case or book case pieces are completed.

For slight changes of the working positions, the time interval available within one work cycle in the form of the difference between the cycle time and the actual processing time can be used for moving the processing devices into new positions by means of motor-driven adjusting systems. The available adjusting time can be extended by operating the case maker with a slower speed. More significant changes of the working positions can be carried out during one or more idle cycles.

Due to the resetting of at least the guides of the board feed that align the cover boards and the spine strips and of the turn-in devices of the side turn-in station, it is at least possible to manufacture book cases of identical height, but different open width without interruption. Particularly book cases with identical covers, but spines of different widths can be manufactured in this way. Due to the relatively narrow range of the spine width and the open width of approximately +/− 15 mm, it is possible to work with a single format of blanks to be covered in this case because the change in width can be compensated with the turn-in width. However, the remaining dimensions of the book case can also be changed by adding other format adjusting axes.

### SUMMARY

The invention replaces the procedure used so far, in which a case maker could not be started before all automatic adjustments were completed and reported as such to the machine master control. Since the respective adjusting times for a certain resetting process to be carried out are stored or can be determined in the control, the manufacture of a next book case can be continued during a production run subsequent to the preceding book case after the longest resetting time of the processing devices to be reset, namely even if a few adjustments are not yet completed or were not even started.

In one preferred additional development, the spine strips are separated from a material web or material sheet fed transverse to the board feed direction in different spine widths. Since the spine strip material is no longer fed longitudinally referred to the spine of the book case, but rather transverse thereto, a different spine width can be realized simply by varying the feed. The width sizing on the material web required so far, as well as the associated resetting expenditures and waste, are eliminated.

In one preferred additional development, the corners of the supplied blanks to be covered are separated with a variable cutting width. The corner section is adapted to the open width and/or height of the book case. Due to this measure, different book case formats can be manufactured with a single format of blanks to be covered.

In one preferred additional development, blanks to be covered of different sizes are cut out of supplied standard sizes. Consequently, a broad range of different book case formats can be manufactured with a single format of blanks to be covered. Significant savings with respect to the printing process, the logistics and the supply of the blanks to be covered are achieved. Furthermore, the resetting of the magazine for blanks to be covered, during which a residual stack that remains for safety reasons would otherwise have to be removed, is also eliminated.

In one preferred additional development, cover boards of different sizes are removed from a supply of cover boards stored in at least one magazine. The cover boards of different sizes can also be fed into a single magazine in the sequence, in which they are processed. Alternatively, at least two board magazines that are assigned to the board feed and contain cover boards of different dimensions are provided, wherein the cover boards can be selectively removed from these magazines.

In one preferred additional development, the supplied blanks to be covered are identified such that the dimensions and the assigned working positions for processing the cover boards, spine strips and blanks to be covered, as well as the book cases to be manufactured thereof, can be determined in order to automatically reset the case maker during the throughfeed of the respective book cases (book case parts).

The data required for the resetting can be retrieved from a data memory that is connected to the control device and preferably incorporated into the internal production planning system. The case maker is preferably integrated into a digital workflow that may include the printing and, if applicable, trimming of blanks to be covered and the sizing of the cover boards, the joining of the book case parts into a book case and even the additional processing in casing-in machines and automates the manufacture of digitally printed books in small print runs by evaluating information on the manufacturing result output by the case maker and initiating the reprinting of a blank to be covered if production errors are detected.

Production errors and stops in the production sequence can be avoided if cover boards, spine strips and/or blanks to be covered that do not belong together are sorted out by means of sorting devices arranged on the board feed and/or blank feed. Manual interventions are significantly reduced in this fashion.

### BRIEF DESCRIPTION OF THE DRAWING

The characteristics of one embodiment are described with reference to the enclosed drawing in which:

FIG. 1 shows a schematic side view of a case maker;

FIG. 2 shows a top view of the case maker; and

FIG. 3 shows a sectional representation according to the view defined in FIG. 1.

### DETAILED DESCRIPTION

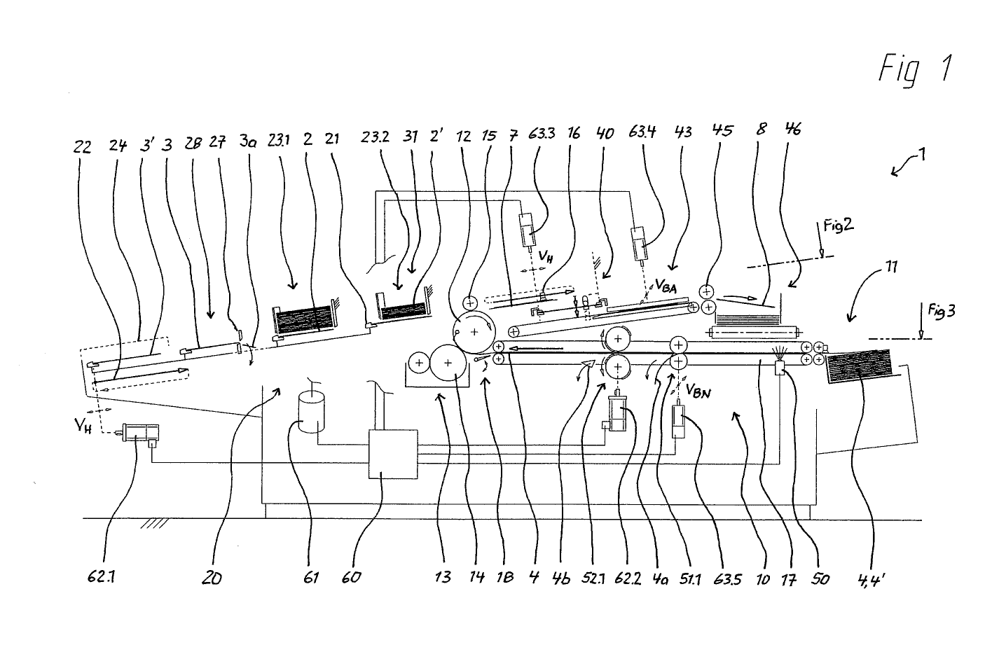

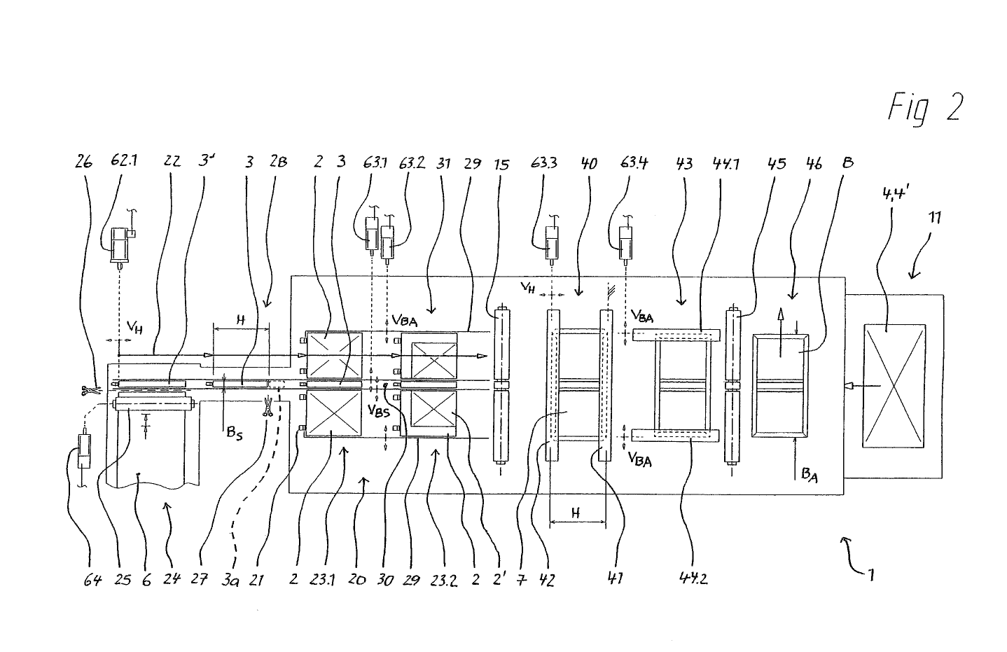

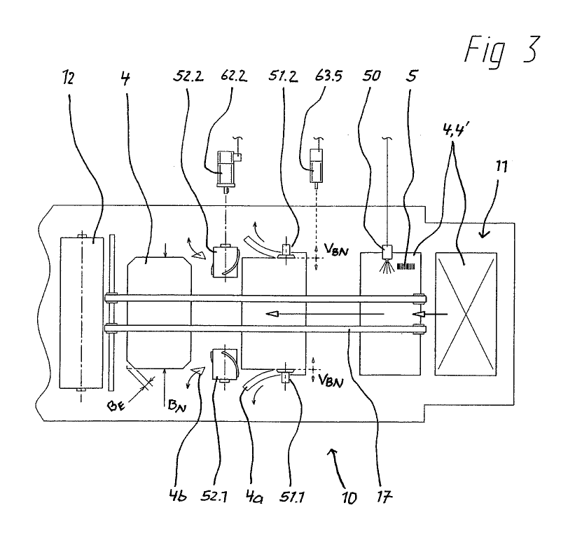

FIGS. 1 to 3 show a case maker 1, in which book cases 8 are manufactured by joining cover boards 2 and spine strips 3 on blanks to be covered 4. One respective blank to be covered 4 is individually removed from a blank magazine 11 and fed to a blank cylinder 12 by a clamping belt conveyor 17 of a blank feed 10. The blank cylinder 12 takes hold of the blank to be covered 4 with grippers, guides it past an application roller 14 of a gluing station 13 and subsequently rolls it down on the two synchronously supplied cover boards 2 and the one spine strip 3 in the joining point.

Pressing rollers 15 press the boards 2, 3 against the blank to be covered 4 in the joining point while a suction bar 16 that carries out a reciprocating motion receives the assembled book case 7 from the roll-down device consisting of the blank cylinder 12 and the pressing rollers 15 in order to feed the book case to a turn-in and rub-down station that consists of a head/foot turn-in station 40 and a side turn-in station 43 for turning in the protruding edges of the blank to be covered, as well as of a pair of pressing rollers 45 for firmly rubbing down the boards 2, 3 on the blank to be covered 4. In a delivery section 46, the finished book cases 8 are stacked and transported to a manual removal station.

The cover boards 2 are situated in a board magazine 23.1. A pair of laterally spaced cover boards is pushed out of the bottom of the magazine by a board pusher 21 of a board feed 20 and guided into an intermediate position 31, from where they are fed to the joining point by another board pusher 21 while they are aligned on the outer board guides 29. The board pushers 21 are coupled to one another at a fixed distance and carry out a cyclic reciprocating motion with a constant feed stroke 22 that is identical to this distance.

Each board strip 3 is pushed forward by the board pushers 21 in a guide channel 30 that can be adjusted to the spine strip width B_{S}, wherein the spine strips 3 are introduced into the guide channel 30 that is extended through the board magazine 23.1 behind the board magazine 23.1. As a consequence, a spine strip 3 is aligned in the space between the pair of boards drawn from the magazine 23.1. A spine strip web 6 from a source strip material such as a flexible center strip roll is inserted into the guide channel 30 transverse to the board feed direction by a pair of pull-off rollers 25 of a center strip feed 24, separated from the spine strip web 6 with the spine strip width B_{S} by means of a cutter 26 and entirely transferred into the guide channel 30 during this process. The coupled board pushers 21 transport the separated spine strip 3 into an intermediate position 28 and then into a position within the board magazine 23.1, from where they are additionally transported to the roll-down device together with the cover boards 2 as a board set by means of the third and fourth feed stroke 22 of the board pushers 21.

The spine strip 3′ separated from the spine strip web 6 may be slightly longer than the required spine strip length. The spine strip length is defined by the book case height H and realized by separating a waste section 3 a on one side by means of a cutter 27 that is arranged on the guide channel 30 in the intermediate position 28.

The case maker 1 with the inventive design makes it possible to manufacture book cases 8 with different dimensions in the form of a continuous production by adjusting at least the guides 29, 30 of the board feed 20 that align the cover boards 2 and spine strips 3, as well as the side turn-in devices 44.1, 44.2 of the side turn-in station 43, to the working positions defined for the respective book case 8 to be manufactured next in synchronism with the throughfeed of the respective book cases 7, 8 and the assigned cover boards 2, spine strips 3 and blanks to be covered 4.

The case maker 1 is reset while the machine is running and book cases 8 are still processed. An adjustment is respectively carried out as soon as the corresponding processing of the preceding book case 7, 8 or book case parts 2, 3, 4 is completed, i.e., the required adjustments are not carried out simultaneously, but rather successively with the throughfeed of the book cases (book case parts). For slight changes in the working positions, the time interval available within one work cycle in the form of the difference between the cycle time and the actual processing time is used as adjusting time. The available adjusting time can be extended by operating the case maker 1 with a slower speed. More significant changes in the working positions are carried out during one or more idle cycles.

The adjustments take place in a motor-driven fashion and are coordinated by a central control 60. Adjustments V_{BA} with respect to the open width B_{A} of the book case 8 can be realized by positioning the outer board guides 29 and the side turn-in devices 44.1, 44.2 by means of adjusting motors 63.2 and 63.4. The adjustment V_{BS} takes into account the spine strip width B_{S}, wherein the width of the guide channel 30 is varied by means of an adjusting motor 63.1 while the respectively required spine strip width B_{S} of the spine strip 3 is supplied due to the changed feed of a step motor 64 connected to the pair of pull-off rollers 25.

The aforementioned adjustments V_{BA} and V_{BS} already make it possible to manufacture book cases 8 of different open width B_{A} and identical height H in an uninterrupted fashion. In this case, the book cases 8 have identical covers, but spines of different widths. As mentioned above, only the width of the spine strip 3 is changed while the formats of the cover boards 3 and blanks to be covered 4 processed therein remain the same. The changing open width B_{A} of the book case 8 is compensated with respect to the fixed blank width B_{N} of the blanks to be covered 4 by varying the turn-in width in the side turn-in station 43. According to this method, book cases 8 of identical height can be manufactured in a spine width B_{S} or open width B_{A} range of approximately +/− 15 mm.

In order to manufacture book cases 8 with a different height H and/or open width B_{A}, cover boards 2, 2′ of different sizes are stored in two board magazines 23.1, 23.2 arranged along the board feed 20 in the exemplary embodiment shown, wherein the cover boards 2, 2′ can be selectively removed from the first or the second board magazine 23.1, 23.2 by the board pushers 21 in accordance with the respective book case size to be manufactured. The flexibility and variance of manufacturing book cases 8 of different sizes in the form of a continuous production can be additionally increased by providing additional board magazines. However, an uninterrupted processing of cover boards 2, 2′ of different sizes can also be realized by feeding the different cover boards 2, 2′ into only one board magazine such as, e.g., the board magazine 23.1 in the sequence, in which they are processed.

In the case maker 1 shown, the leading edge of the cover boards 2, 2′ and spine strips 3 is defined as fixed reference edge as indicated by the front edge stops of the board magazines 23.1, 23.2 that are rigidly arranged on the frame. Consequently, the processing of cover boards 2, 2′ and spine strips 3 of different heights requires a format adjustment VH of the stroke position of the constant feed stroke 22, wherein this format adjustment is realized by electronically adjusting a servomotor 62.1 that serves as the drive for the board pushers 21. In addition, the book case height H is also adjusted in the head/foot turn-in station 40, wherein a foot turn-in device 42 is displaced relative to a head turn-in device 41 that is rigidly arranged on the frame by means of an adjusting motor 63.3.

Left and right corner cutters 52.1, 52.2 are arranged along the blank feed 10 and trim corner sections 4 b with a cutting width B_{E} from the leading and trailing edge during the throughfeed of the blanks to be covered 4. The rotative tools of the corner cutters 52.1, 52.2 are driven by a servomotor 62.2 that makes it possible to electronically adjust the cutting width B_{E} in accordance with the respective height H and open width B_{A} of the book cases 8.

In addition, left and right lateral cutters 51.1, 51.2 with driven circular knives are arranged along the blank feed 10 and separate lateral edge sections 4 a from wider blanks to be covered 4′ during the throughfeed of the blanks to be covered 4. In order to realize the respectively required blank width B_{N}, it is possible to carry out an adjustment V_{BN} that positions the pairs of circular knives of the lateral cutters 51.1, 51.2 to the corresponding blank width B_{N} by means of an adjusting motor 63.5. Due to this measure, blanks to be covered 4 of different sizes can be cut out of blanks to be covered 4′ that are supplied in standard sizes. Furthermore, a transverse cutter that is not illustrated in the exemplary embodiment may be arranged along the blank feed 10 in order to cut the blanks to be covered to the respectively required blank height.

In order to realize a flawless and, in particular, automated manufacture of book cases 8 of different dimensions, the control 60 is connected to generally known sensors that are arranged at different locations of the material flow in order to identify the book case parts to be processed and their characteristics, wherein this makes it possible, among other things, to check if the cover boards 2 and spine strips 3 fed to the joining point, as well as the blanks to be covered 4, are suitable for one another and have the correct dimensions. Book case parts that do not belong together such as, e.g., an incorrectly supplied blank to be covered 4 are sorted out by means of sorting devices 18 prior to the joining process.

As an example, a sensor 50 for scanning a barcode 5 or similar indicia printed on the blanks to be covered 4, 4′ is arranged at the inlet of the blank feed 10 in the exemplary embodiment shown. The supplied blanks to be covered 4, 4′ can be identified in this fashion. This identification makes it possible to determine the dimensions and the corresponding working positions for processing the cover boards 2, spine strips 3 and blanks to be covered 4 and for manufacturing the book cases 8, wherein the input signal from the sensor to the control 60 results in an adjustment of the above-described processing devices successively with the throughfeed of the respective book cases (book case parts) 2, 3, 4, 7, 8.

The data required for the adjustment may be stored directly in the barcode 5 or is retrieved from a data memory 61 that is connected to the control 60 and incorporated into an internal production planning system.

1. A method for the continuous manufacturing of book cases (8) of different dimensions, in which for each different book case there are assigned cover boards (2), spine strip board (3), and a blank (4), and defined working positions of various guides and turning-in devices, comprising:
with a board feeder (20), continuously supplying a board set along a board processing linear direction to a joining point (15) for a blank to be covered, said board set including spaced apart cover boards between adjustable alignment guides (29) and a spine board strip between adjustable alignment guides (30) in the space between the cover boards;
cyclically supplying glued blanks (4) to the joining point (15), where the board set and glued blank are rolled down in a continuous through feed of a board set being processed and a next board set to be processed, in which for the board set being processed, edges of the blank protrude from the cover boards;
placing the protruding edges of the blank onto the boards (2, 3) around the board edges by adjustable turn-in devices (41, 42, 44.1, 44.2) in a head/foot turn-in station and a side turn-in station (40, 43) situated downstream of the joining point and thereby form book cases; and
rubbing down the formed book cases with pressing rollers (45) to complete the manufacture of the book cases;
wherein book cases (8) of different dimensions are manufactured in a continuous through feed operation by adjusting at least the guides (29, 30) of the board feed (20) that align the cover boards (2) and spine strips (3), and the turn-in devices (44.1, 44.2) of the side turn-in station (43), to the working positions defined for the respective book case (8) to be processed next in synchronism with the throughfeed of the respective book cases (7, 8) and their assigned cover boards (2), spine strips (3) and blanks to be covered (4).

2. The method according to claim 1, wherein spine strips (3, 3′) with different spine widths (Bs) are separated from a source of spine board material that is supplied transverse to the board processing direction.

3. The method according to claim 1, wherein the supplied blanks to be covered (4) have corners and the corners are trimmed with a variable cutting width (B_{E}) before the blanks are glued.

4. The method according to claim 1, wherein the blanks to be covered (4) of different sizes are cut out of supplied standard sizes (4′).

5. The method according claim 1, wherein the cover boards (2, 2′) of different sizes are removed from a supply of cover boards (2, 2′) that is stored in at least one magazine (23.1, 23.2).

6. The method according to claim 1, wherein the supplied blanks to be covered (4, 4′) carry identification indicia that corresponds to said dimensions and said assigned working positions.

7. The method according to claim 2, wherein the supplied blanks to be covered (4) have corners and the corners are trimmed with a variable cutting width (B_{E}) before the blanks are glued.

8. The method according to claim 2, wherein the supplied blanks to be covered (4, 4′) carry identification indicia that corresponds to said dimensions and said assigned working positions.

9. The method according to claim 1, wherein an adjustment for a next book case to be manufactured is respectively carried out successively for each of the guides (29, 30) of the board feed (20) that align the cover boards (2) and spine strips (3), and the turn-in devices (44.1, 44.2) of the side turn-in station (43), as soon as the corresponding processing of the preceding book case 7, 8 or book case parts 2, 3, 4 is completed.

10. The method according to claim 1, wherein
spine strips (3, 3′) with different spine widths (Bs) are supplied from a source;
the blanks to be covered (4) of different sizes are cut with corners out of supplied standard sizes (4′);
the corners are trimmed with a variable cutting width (B_{E}) before the blanks are glued.

11. The method according to claim 10, wherein the supplied blanks to be covered (4, 4′) carry identification indicia that corresponds to said dimensions and said assigned working positions.

12. The method according to claim 10, wherein an adjustment for a next book case to be manufactured is respectively carried out successively for each of the guides (29, 30) of the board feed (20) that align the cover boards (2) and spine strips (3), and the turn-in devices (44.1, 44.2) of the side turn-in station (43), as soon as the corresponding processing of the preceding book case 7, 8 or book case parts 2, 3, 4 is completed.

13. The method according to claim 11, wherein an adjustment for a next book case to be manufactured is respectively carried out successively for each of the guides (29, 30) of the board feed (20) that align the cover boards (2) and spine strips (3), and the turn-in devices (44.1, 44.2) of the side turn-in station (43), as soon as the corresponding processing of the preceding book case 7, 8 or book case parts 2, 3, 4 is completed.
